(19) United States
(12) Patent Application Publication
(10) Pub. No.: US 2026/0338590 A1
(43) Pub. Date: Oct. 29, 2026

(54) LOW-POWER-BASED GROUNDWATER LEVEL MEASUREMENT METHOD FOR GROUNDWATER MONITORING AUTOMATION AND GROUNDWATER PROTECTION WORK FOR PERFORMING THE SAME

(71) Applicants: ENIN CO., LTD., Incheon (KR); Korea Radioactive Waste Agency, Gyeongju-si (KR)

(72) Inventors: Whun LEE, Gwangmyeong-si (KR); Geun Taek LIM, Incheon (KR); Geon Ho LEE, Bucheon-si (KR); Soon Il OK, Busan (KR)

(73) Assignees: ENIN CO., LTD., Incheon (KR); Korea Radioactive Waste Agency, Gyeongju-si (KR)

(21) Appl. No.: 19/339,806

(22) Filed: Sep. 25, 2025

(30) Foreign Application Priority Data
Apr. 28, 2025 (KR) 10-2025-0055409

(51) Int. Cl. G01F 23/44

(52) U.S. Cl. CPC G01F 23/44

(57) ABSTRACT

According to an embodiment of the present disclosure, a groundwater protection work for measuring a groundwater level according to winding or unwinding a wire connected to a water level float may include a wire drum that winds and stores the wire, a spring drum connected to a gearbox or the wire drum and configured to rotate in a forward or reverse direction according to tension of the wire to maintain the tension of the wire, the gearbox configured to reduce rotation of the wire drum and transmit the reduced rotation to the spring drum, and a rotation measurement unit configured to measure a rotation direction and the number of rotations by rotating together with the wire when the wire is wound on or unwound from the wire drum and measure the groundwater level based on the measured number of rotations.

### CROSS-REFERENCE TO RELATED APPLICATION

This application claims priority to and the benefit of Korean Patent Application No. 2025-0055409, filed on Apr. 28, 2025, the disclosure of which is incorporated herein by reference in its entirety.

### BACKGROUND

### 1. Field of the Invention

The technical idea of the present disclosure relates to a groundwater protection work, and more particularly, to a groundwater protection work for measuring a groundwater level.

### 2. Discussion of Related Art

A water level gauge inserted into a groundwater protection work is an essential device that monitors a groundwater level and supports the protection and efficient use of resources. Conventionally used water level gauges do not have sufficient low-power characteristics, which has made it difficult to perform long-term continuous monitoring and has imposed maintenance burdens such as replacing or recharging a battery.

In addition, since a water depth is often very high, a wire connected to a water level float should be considerably long. However, a process of winding or unwinding a long wire manually or with a simple driving device consumes much energy, and thus its application is limited in environments in which low-power driving is required.

Additionally, it was not easy to design or install a large drum that can accommodate the entirety of a long wire. As a drum becomes larger, the volume and weight of the entire device increase, which makes installation and management more complex. In addition, it becomes more difficult to control the rotational force of the drum itself, which may cause problems in maintaining wire tension.

### SUMMARY OF THE INVENTION

The present disclosure is directed to providing a groundwater protection work in which, in order to minimize energy generated in a process of winding or unwinding a wire and accommodate a long wire in a small drum, a high-reduction gearbox and a spring drum are combined to stably manage a wire at low power.

According to an aspect of the present invention, there is provided a groundwater protection work for measuring a groundwater level according to winding or unwinding a wire connected to a water level float, which includes a wire drum configured to wind the wire and store the wound wire, a spring drum connected to at least one of a gearbox and the wire drum and configured to rotate in a forward or reverse direction according to tension of the wire to maintain the tension of the wire, the gearbox disposed between the wire drum and the spring drum and configured to reduce rotation of the wire drum and transmit the reduced rotation to the spring drum, and a rotation measurement unit configured to measure a rotation direction and the number of rotations by rotating together with the wire when the wire is wound on or unwound from the wire drum and measure the groundwater level based on the measured number of rotations.

The spring drum may include a torsion spring having a rotation shaft aligned with that of at least one of the gearbox and the wire drum.

Required torque of the torsion spring may be proportional to a load acting on the wire and a radius of the spring drum.

The gearbox may be connected to the spring drum while sharing a first rotation shaft and may be connected to the wire drum while sharing a second rotation shaft different from the first rotation shaft, and a rotation ratio of the second rotation shaft to the first rotation shaft may be determined according to the number of gears included in the gearbox and a gear ratio of the gears.

The gearbox may have a reduction ratio of 768:1 by connecting five first gears having a gear ratio of 1:4 to one second gear having a gear ratio of 1:3.

When the wire drum rotates 768 times, the spring drum may rotate at an angle of 270 degrees or less.

The spring drum may rotate less than one revolution while the wire drum winds a wire with a length of 200 m or more.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A-1B show views illustrating a groundwater protection work according to an embodiment of the present disclosure;

FIGS. 2A-2C show views illustrating components of a water level measurement module installed in the groundwater protection work according to one embodiment;

FIG. 3 is a view illustrating an embodiment in which a wire is unwound as a groundwater level drops according to one embodiment;

FIG. 4 is a view illustrating an embodiment in which a wire is wound as a groundwater level rises according to one embodiment;

FIG. 5 is a view illustrating a gearbox according to one embodiment;

FIG. 6 is a view illustrating a spring drum according to one embodiment;

FIG. 7A is a view illustrating an embodiment in which a pulley is installed perpendicular to a ground surface according to one embodiment; and

FIG. 7B is a view illustrating an embodiment in which a groundwater level is measured in a state in which a cover of the groundwater protection work is opened according to one embodiment.

### DETAILED DESCRIPTION OF EXEMPLARY EMBODIMENTS

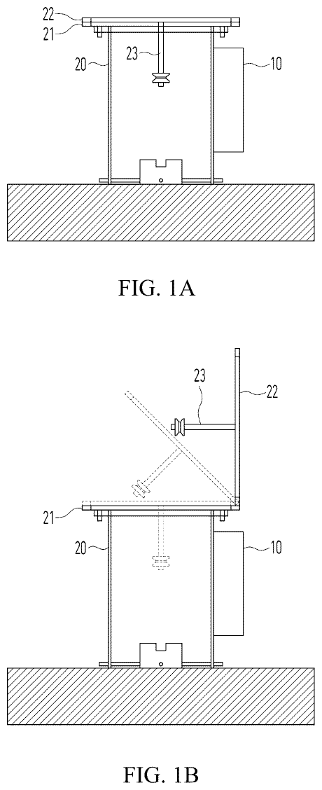

FIG. 1 shows views illustrating a groundwater protection work 20 according to an embodiment of the present disclosure.

Throughout the present disclosure, the same reference numerals refer to the same components. The present disclosure does not describe all components of embodiments, and general contents or duplicated contents between the embodiments in the technical field to which the present disclosure pertains will be omitted. The terms “unit, module, member, and block” used herein may be implemented in software or hardware, and according to embodiments, the plurality of “units, modules, members, and blocks” may be implemented in one component or one “unit, module, member, and block” may include a plurality of components.

Throughout the specification, when it is described that a first component is “connected” to a second component, this includes not only a case in which the first component is directly connected to the second component but also a case in which the first component is indirectly connected to the second component, and the indirect connection includes connection through a wireless communication network.

Further, when a part “includes” a component, this means that a third component is not excluded but may be further included unless otherwise stated.

Throughout the specification, when a first member is located “on” a second member, this case includes not only a case in which the first member is in contact with the second member but also a case in which a third member is present between the two members.

Terms such as first and second are used to distinguish one component from another component, and components are not limited by the above-described terms.

Singular expressions include plural expressions unless clearly otherwise indicated in the context.

In each operation, an identification code is used for convenience of description and does not describe a sequence of the operations, and an operation may be performed in a different order from a specified order unless the context clearly states a specific order.

Hereinafter, the operating principles and embodiments of the present disclosure will be described with reference to the accompanying drawings.

Referring to FIG. 1, a water level measurement module 10 of the present disclosure may be installed on a side surface of the groundwater protection work 20 to measure a groundwater level, and in particular, may be configured to accurately measure a water level with low power by using a long wire. The groundwater protection work 20 serves as a main body of a groundwater level monitoring system, and a flange 21 installed at an upper end portion thereof serves to stably support a water level measurement unit and a cover 22.

Specifically, the flange 21 may be installed at the upper end portion of the groundwater protection work 20. The flange 21 may be provided as the upper end portion of the groundwater protection work and installed around an opening, and a side surface thereof may be sealed to prevent foreign materials from easily penetrating through the groundwater protection work. The cover 22 may be hinge-coupled to the flange 21 and may be installed to be opened and closed relative to the flange 21. The cover 22 may protect the inside of the groundwater protection work 20 from foreign materials and may be opened for inspection and maintenance when necessary.

A pulley 23 is installed on the cover 22. The pulley 23 serves to guide and support a wire used for water level measurement and allows the wire to be smoothly wound and unwound. The pulley 23 may be a component that smoothly and stably guides a float toward groundwater in a state in which a wire of the water level measurement module is hung thereon, but is not limited thereto. The pulley 23 of the present disclosure may be a component that stably guides various types of sensors toward groundwater.

The water level measurement module 10 used for water level measurement may be fixed to a sidewall of the groundwater protection work 20 and may measure a groundwater level based on a degree of rotation of a rotor of a rotation measurement unit by a wire. The degree of rotation may include information about a rotation direction, the number of rotations, and a rotation angle as rotation information, and the rotation information of the rotor may be measured by an encoder of the rotation measurement unit.

FIG. 1A illustrates a state in which the cover 22 is closed. In this case, the pulley 23 may be disposed above the flange 21. FIG. 1B illustrates a state in which the cover 22 is opened, and the pulley 23 is provided to stably guide a wire above the flange 21 even when the cover 22 is rotated and opened.

Due to such a configuration, in the present disclosure, even when a long wire is used, the winding and unwinding of the wire can be stably controlled, and reliable water level measurement can be performed with low power consumption. In addition, maintenance work can be easily performed by opening or closing the cover 22.

According to one embodiment, a bearing may be installed between the flange 21 and the cover 22. The bearing performs a function of supporting the cover 22 such that the cover 22 may rotate smoothly with respect to the flange 21.

That is, the cover 22 may be disposed to be rotatable along the bearing installed on the flange 21. Thus, a user may easily rotate the cover 22 on the flange 21 to adjust a direction of the pulley 23 and may adjust a direction in which a wire hung a sensor is lifted according to the adjusted direction of the pulley 23. In addition, the user may adjust the direction of the pulley 23 to set a direction for lifting a float floating on groundwater. A wire used for water level measurement moves through the pulley 23 to change a drawing direction of the wire according to the external environment, the structural condition of the groundwater protection work 20, or the position of the water level measurement module 10.

Accordingly, the cover 22 is rotated on the flange 21 to adjust the direction of the pulley 23, thereby optimizing the drawing direction of the wire. Thus, as the wire smoothly passes through the pulley 23, friction and stress can be minimized, wire damage and measurement errors can be prevented.

In addition, since the cover 22 smoothly rotates through the bearing, the user can easily adjust the position of the cover 22 along a drawing direction of the wire, thereby enabling stable and accurate water level measurement even in various installation environments.

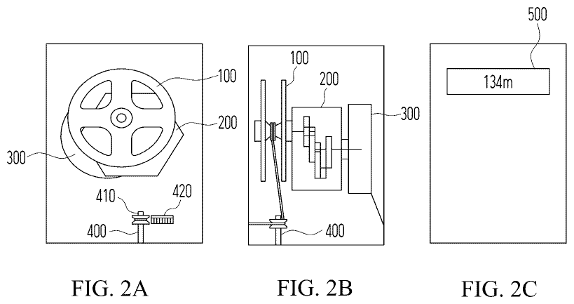

FIG. 2 shows views illustrating components of the water level measurement module 10 installed in the groundwater protection work 20 according to one embodiment.

Referring to FIG. 2, the water level measurement module 10 may include a wire drum 100, a gearbox 200, a spring drum 300, and a rotation measurement unit 400. The rotation measurement unit 400 may include a rotor 410 that rotates whenever a wire is wound or unwound, and an encoder 420 that measures rotation information of the rotor 410.

In addition, referring to FIG. 2C, a display unit 500 may be disposed in a case of the water level measurement module 10 and may display a groundwater level corresponding to a wire length. For example, a processor of the encoder 420 may calculate a wire length based on rotation information and may provide information such that the wire length may be displayed on the display unit 500. The display unit 500 may be provided as a seven-segment display to allow a user to check a water level. In addition, the display unit 500 operates in an inactive state that is a default state and displays a water level only when a display button is pressed, thereby minimizing power consumption.

The wire drum 100 serves to wind or unwind a wire connected to a water level float. The wire drum 100 may rotate as the wire is wound and unwound, thereby reflecting a change in water level.

The gearbox 200 is connected between the wire drum 100 and the spring drum 300 to reduce the rotation of the wire drum 100 to transmit the reduced rotation to the spring drum 300. In this case, a reduction ratio may be appropriately set to minimize a rotation amount of the spring drum 300 and suppress spring fatigue even when a wire length is long.

The spring drum 300 includes a torsion spring therein to allow constant tension to be always maintained when a wire is unwound or wound. Thus, the spring drum 300 prevents the wire from becoming too loose or too tense and supports stable water level measurement.

The rotation measurement unit 400 is installed to measure rotation information of the wire drum 100 or the rotor 410. For example, the rotation measurement unit 400 includes the rotor 410 and the encoder 420 that detects a rotation amount of the rotor 410. The encoder 420 may transmit rotation information to the processor, and the processor may calculate a wire length based on the rotation information. The present disclosure is not limited thereto, and the rotation measurement unit 400 may also measure the number of rotations, a rotation direction, and a rotation angle of the wire drum 100.

In addition, the display unit 500 may be provided on an outer case of the water level measurement module 10. The display unit 500 serves to display a groundwater level to a user based on a wire length calculated by the processor. The display unit 500 may be provided, for example, as a seven-segment display.

The display unit 500 may be configured to maintain an inactive state as a default state to minimize power consumption and display a current water level only when a user presses the display button. Thus, the water level measurement module may stably operate for a long time even in low-power operating environments.

According to one embodiment, in the water level measurement module 10 of the present disclosure, the spring drum 300 and the wire drum 100 are each provided to rotate around an independent rotation shaft.

Specifically, the spring drum 300 is installed to be rotatable around a first rotation shaft. The first rotation shaft is connected to the gearbox 200, and the torsion spring provided inside the spring drum 300 twists along the first rotation shaft to provide necessary tension to a wire. The spring drum 300 is connected to the wire drum 100 through the gearbox 200, but only receives rotational motion reduced through a gear ratio to rotate only within a predetermined rotation range (for example, an angle of 270 degrees or less).

Meanwhile, the wire drum 100 is installed to be rotatable around a second rotation shaft. The second rotation shaft is supported such that the wire drum 100 may directly perform winding and unwinding operations of a wire. As a wire connected to the water level float moves, the wire drum 100 freely rotates around the second rotation shaft, and such rotational motion is detected through the rotation measurement unit 400.

In this way, the spring drum 300 is provided to independently rotate around the first rotation shaft, and the wire drum 100 is provided to independently rotate around the second rotation shaft, thereby enabling stable tension maintenance and precise water level measurement even when using a long wire. In addition, the excessive rotation of the spring drum 300 is prevented by a reduction mechanism through the gearbox 200, thereby significantly improving the durability and reliability of a system.

According to one embodiment, the spring drum 300 is connected to the gearbox 200, and the rotational motion of the first rotation shaft is reduced through the gearbox 200 and then transmitted to the second rotation shaft. The second rotation shaft is supported so that the wire drum 100 may directly perform winding and unwinding of a wire and receives reduced rotational motion to smoothly move the wire.

Specifically, the rotation of the first rotation shaft generated in the spring drum 300 is reduced in multiple stages through a plurality of gears installed inside the gearbox 200. A reduction ratio may be set to, for example, 768:1, and thus while the spring drum 300 rotates only at a predetermined angle (for example, an angle of 270 degrees or less), the wire drum 100 may rotate multiple times to wind or unwind a long wire.

Through the independent configurations of the first and second rotation shafts and a reduction transmission mechanism, while a long wire is used, it is possible to minimize the rotation fatigue of the spring drum 300, stably maintain wire tension, and improve the precision of water level measurement and durability of a system.

According to one embodiment, the rotor 410 of the rotation measurement unit 400 may rotate in a direction in which a wire moves whenever the wire is caught and moved. A groove of the rotor 410 through which a wire passes may be formed in a precisely designed spiral type structure and may be formed to have a two-turn helix so that the rotor 410 may consistently rotate whenever the wire moves.

The encoder 420 of the rotation measurement unit 400 may measure a rotation direction, the number of rotations, and a rotation angle and may calculate a movement length of a wire based on measured rotation information. For example, the encoder 420 may be a magnetic encoder and may be mounted on the wire drum 100 or the rotor 410 to precisely detect a rotation angle.

A wire length L calculated by the encoder 420 may be calculated according to the following equation.

L=2π×r×N. [Equation 1]

r may be a radius of a wire groove, and N may be the number of rotations. Due to the design characteristics of a spiral type groove, the rotor may guide a wire consistently and precisely along a two-turn spiral type structure, and accurate water level conversion may be performed based on the detected number of rotations.

A magnetic encoder may detect a change in relative position between a magnet and a sensor in a non-contact manner and may convert an angle into a digital signal. For example, the magnetic encoder may communicate with a processor through an inter-integrated circuit (I2C) or pulse width modulation (PWM) output method and may provide high-resolution (for example, 12 bits, 4,096 steps per revolution) precise rotation values in real time. Thus, a rotation amount of the wire drum 100 or the rotor 410 may be accurately tracked, and a measured value may be converted into a water level value in real time by a water level calculation algorithm.

A wire may be made of a metal wire with strong tensile strength such as stainless steel and may be connected to a float to be wound on or unwound from a wire drum according to a change in water level. The float may have a structure floating on a water surface and may induce the rotation of the wire drum 100 and the spring drum 300 by pulling the wire upward or downward according to a change in water level. The water level measurement module 10 according to the embodiment of the present disclosure may be provided to be attachable to and detachable from the groundwater protection work 20 and may be provided to be easily attachable and detachable on a site during maintenance and replacement.

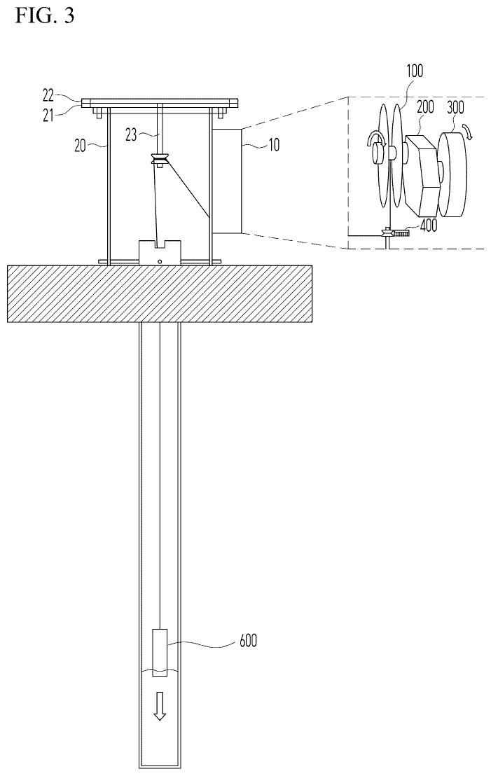

FIG. 3 is a view illustrating an embodiment in which a wire is unwound as a groundwater level drops according to one embodiment.

Referring to FIG. 3, when a groundwater level drops, as a float 600 also descends, the wire may be unwound from the wire drum 100. To this end, a water level measurement system according to the present disclosure has a structure in which a balance of force is precisely set such that the float 600 may naturally ascend or descend according to a groundwater level. In the float 600, gravity G due to its own weight, underwater buoyancy B, tension T generated by the wire, and an elastic force Fs provided by the torsion spring of the spring drum 300 interact with each other.

The float 600 has a tendency to descend in a downward direction due to the influence of the gravity G and simultaneously receives an upward force due to the buoyancy B. The float 600 is connected to the wire, and the wire receives a tensile force through the wire drum 100 and the spring drum 300 in the water level measurement module 10. The spring drum 300 provides continuous tension to the wire through the torsion spring installed therein, thereby preventing the wire from loosening.

In this case, in order for the float 600 to naturally descend in the downward direction, the gravity G acting on the float 600 should be greater than the sum of the buoyancy B and the tension T. That is, the gravity G should be greater than the total upward force B+T received by the float 600. The tension T generated by the elastic force Fs of the torsion spring should be set not to impede the float 600 from naturally descending due to gravity. This is intended to prevent the spring drum 300 from providing an excessive elastic force to suppress the movement of the float 600 and allow the wire to always remain appropriately tensioned.

Therefore, in the present disclosure, the elastic force of the torsion spring is adjusted to tension the wire within a range that does not impede the descent of the float 600. Thus, the float 600 may naturally descend as a groundwater level drops, and at the same time, the tension of the wire is appropriately maintained so that a change in position of the float 600 may be precisely detected. Such a balance of force contributes to improving both the reliability of water level measurement data and the durability of a system.

In the water level measurement module 10 according to the embodiment of the present disclosure, as the wire is unwound, the wire drum 100 and the spring drum 300 may be rotated in a first direction, and the rotor 410 of the rotation measurement unit 400 rotated by the wire may also be rotated in a corresponding direction. In this case, a rotation ratio of the wire drum 100 to the spring drum 300 may be proportional to a gear ratio of the gearbox 200. The rotation ratio may be a ratio of a rotation angle at which the wire drum 100 rotates to a rotation angle at which the spring drum 300 rotates. For example, when the spring drum 300 rotates 3 degrees while the wire drum 100 rotates 2 turns, the rotation angle at which the wire drum 100 rotates may be 720 degrees, the rotation ratio may be 240:1 (720:3), and the gear ratio may be 240:1. The gear ratio according to the embodiment of the present disclosure is not limited thereto and may include all of gear ratios that can be implemented in the gearbox 200.

The encoder 420 may acquire a rotation direction, a rotation angle, and the number of rotations by the rotor 410 as rotation information. The encoder 420 may calculate a length of the wound wire by calculating the acquired rotation information and may calculate a changed groundwater level by adding the calculated length of the wire to a previously stored groundwater level.

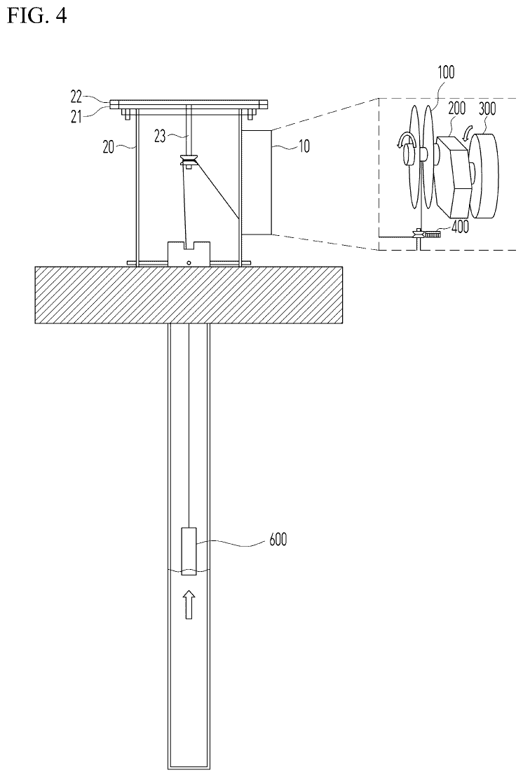

FIG. 4 is a view illustrating an embodiment in which a wire is wound as a groundwater level rises according to one embodiment.

Referring to FIG. 4, when a groundwater level rises, as the float 600 also ascends, the wire may be wound on the wire drum 100. In the water level measurement system of the present disclosure, when the groundwater level rises, the float 600 ascends upward as the buoyancy B increases. In such a process, the gravity G, the buoyancy B, the tension T through the wire, and the elastic force Fs generated by the torsion spring of the spring drum 300 act on the float 600 in balance with each other.

As the groundwater level rises, a volume of the float 600 submerged in water increases, and, accordingly, the buoyancy B significantly increases. Since the buoyancy B increases in proportion to a volume of water displaced by the float 600, a force pushing the float upward becomes stronger as a water level rises.

In this case, the gravity G of the float 600 still acts in a downward direction, but once the buoyancy B becomes greater than the gravity G, the float 600 begins to ascend upward. Since the float 600 is connected to the wire, a tensile force is generated along the wire when the float 600 ascends, and the tensile force is transmitted to the wire drum 100 and the spring drum 300.

In particular, when the wire is pulled upward by the ascent of the float 600, the torsion spring installed in the spring drum 300 gradually accumulates the elastic force Fs while rotating in a winding direction. The spring drum 300 is designed to wind the wire toward the wire drum 100 while maintaining predetermined torque, and the elastic force Fs is adjusted such that the float 600 may naturally ascend without excessive resistance.

Eventually, when the float 600 ascends due to the buoyancy B as a water level rises,

A force relationship buoyancy of B>gravity G+tension T should be satisfied. The tension T is a tensile force applied by the wire and is directly associated with the elastic force Fs of the torsion spring. The tension T should be appropriate not to impede the ascent of the float 600 and functions to allow the natural upward motion of the float 600 and simultaneously prevent the wire from loosening.

When the water level rises, the float 600 naturally ascends due to the increased buoyancy B, and the elastic force Fs of the torsion spring winds the wire on the wire drum 100 while maintaining the wire in an appropriate tension state. Thus, a change in position of the float 600 may be precisely detected, and accurate measurement according to a change in water level may be performed.

According to one embodiment, the float 600 should naturally descend or ascend according to a change in groundwater level, and in this case, the torsion spring of the spring drum 300 should be set to maintain appropriate tension in the wire without impeding the movement of the float 600.

In consideration of the descent of the float 600, the gravity G acts on the float 600 to apply a force in the downward direction. In this case, the constant elastic force Fs is applied to the wire connected to the float 600 by the torsion spring of the spring drum 300 so that a force is applied in a direction in which the wire is to be wound. In order for the float 600 to naturally descend, the gravity G acting on the float 600 should be greater than the sum of the buoyancy B and the tension T, and the tension T is determined by the elastic force Fs of the torsion spring. Therefore, during descent, the gravity of the float 600 should be sufficiently greater than the elastic force Fs provided by the spring drum 300, and the float 600 should not be excessively supported or resisted upward by the elastic force such that the descent is not impeded.

On the other hand, when the float 600 is to ascend as the groundwater level rises, the sum of the buoyancy B and the elastic force Fs acting on the float 600 in an upward direction should be greater than the gravity G. That is, a condition for ascent is summarized as B+Fs>G. In this case, the float 600 naturally ascends by the combined force of the buoyancy and the elasticity, and the wire is wound on the wire drum 100 to maintain a tension state.

In summary, the following relationship should be established between the gravity G generated by the weight of the float 600 and the elastic force Fs of the spring drum 300. During descent, the float 600 should naturally descend by satisfying G>Fs+B, and during ascent, the float 600 should also naturally ascend by satisfying B+Fs>G. Here, the elastic force Fs should be sufficiently large to maintain the tension of the wire and should be appropriately set not to impede the natural movement of the float 600.

Based on such a force relationship, in the present disclosure, a stiffness coefficient k and initial torque of the torsion spring may be appropriately set, thereby implementing a design that satisfies both of free movement of the float 600 according to a change in water level and maintenance of the tension state of the wire.

The elastic force Fs of the torsion spring is generally determined by a spring constant k and a rotation angle θ. That is, the elastic force Fs may be represented by Fs=k×θ. Here, k is an elastic modulus of a spring, and θ is an angle by which the spring is twisted. Therefore, when the spring drum 300 is designed, a k value should be set to provide a necessary elastic force within an appropriate rotation angle range in consideration of a maximum ascent distance of the float 600, a reduction ratio with the wire drum 100, or the like.

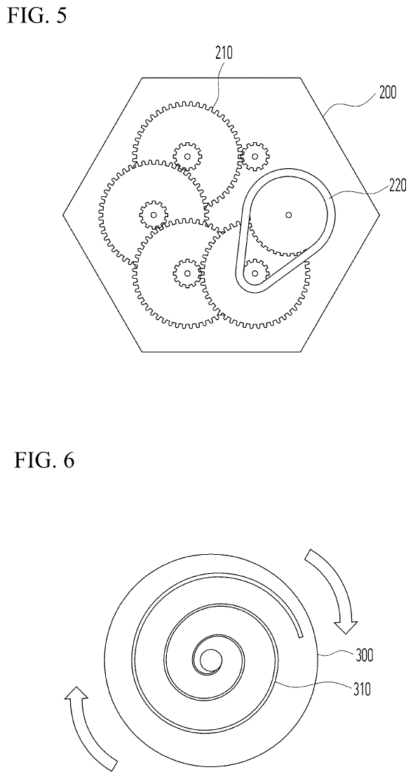

FIG. 5 is a view illustrating the gearbox 200 according to one embodiment.

Referring to FIG. 5, the gearbox 200 may include a plurality of 1:4 gears as first gears 210 and a 1:3 gear as a second gear 220. The gearbox 200 is installed between the rotation shafts of the wire drum 100 and the spring drum 300 and allows the rotation of the wire drum 100 to be transmitted to the spring drum 300 after being reduced in multiple stages without being directly transmitted. Specifically, in the gearbox 200, the first gears 210 having a gear ratio of 1:4 are provided in five stages, and then the second gear 220 having a gear ratio of 1:3 is additionally provided in one stage, thereby implementing a total high reduction ratio of 768:1.

Due to such a configuration, while the wire drum 100 rotates 768 times, the spring drum 300 rotates only up to 270 degrees. Therefore, even when a long wire, for example, a wire with a length exceeding 200 m, is wound or unwound, a rotation amount of the spring drum 300 is very small, thereby effectively suppressing the accumulation of spring fatigue.

In addition, through a high reduction ratio of 768:1, precise rotation control according to the movement of a long wire is possible, thereby significantly improving the accuracy of water level measurement. In particular, even when a long wire is used, errors due to drawing and winding of the wire are minimized, thereby enabling reliable water level measurement in the long term.

The configuration of the gearbox 200 of the present disclosure not only achieves a high reduction ratio but also contributes to maintaining stable torque of the spring drum 300 and enhancing the durability of the entire system.

The number and gear ratio of gears included in the gearbox 200 of the present disclosure are not limited thereto and may be appropriately selected according to the length of the required wire and the strength of the torsion spring.

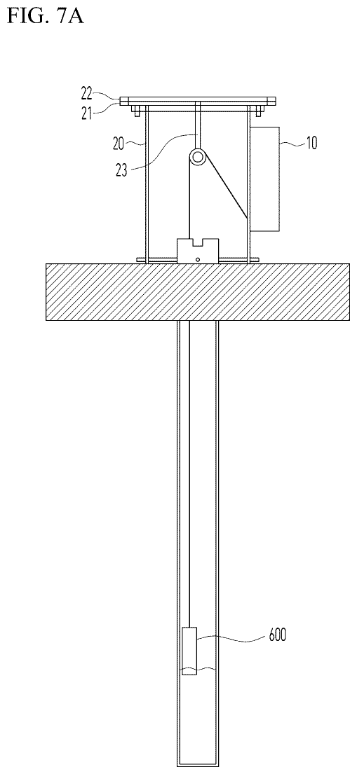

FIG. 6 is a view illustrating the spring drum 300 according to one embodiment.

Referring to FIG. 6, the spring drum of the present disclosure may include the torsion spring, and the torsion spring may be formed in a planar spiral type structure. The torsion spring should not generate an excessive elastic force while the float 600 is ascending or descending. The elastic force Fs provided by a torsion spring should be set to a level that maintains an appropriate tension state of the wire without impeding the free movement of the float 600. For this purpose, the stiffness coefficient k of the spring should be determined in consideration of the gravity G of the float 600, the predicted buoyancy B, the moving distance of the wire (change in length), or the like.

Additionally, a spiral type torsion spring should be able to maintain a constant torque characteristic even when a winding or unwinding angle θ is large. Since the float 600 may move several tens of meters or more within the groundwater protection work 20, an operational range of a spring should be sufficiently secured. An allowable torsion angle (allowable θ) of a spring should be set to correspond to the maximum movement distance of the float 600, and in such a process, the spring should be able to maintain a sufficient elastic restoring force without undergoing plastic deformation.

In particular, due to a structure of a planar spiral type torsion spring, torque may nonlinearly increase as a rotation angle increases. Therefore, during design, an initial elastic force should not be set excessively high, and an initial winding amount (pre-load) should be adjusted to provide only appropriate basic tension at an initial position of the float 600 (for example, in a normal water level state). Thus, the float 600 may freely ascend and descend according to a change in water level, and at the same time, the wire may be prevented from becoming loose.

In conclusion, in order to satisfy both the free movement of the float 600 and the tension state of the wire, in the present disclosure, the flat spiral type torsion spring is optimized by precisely setting the stiffness coefficient k, the allowable rotation angle θ, and the initial winding state of a spring.

According to one embodiment, torque required for the torsion spring may be proportional to a load acting on the wire and a radius of the spring drum 300. The load acting on the wire may be a value obtained by subtracting the buoyancy from the gravity of the float 600, and the buoyancy may have a fixed value proportional to a volume of the float 600 submerged in water. That is, when the radius of the spring drum 300 is fixed, the torque required for the torsion spring may be determined according to the weight of the float 600.

Spring stiffness may be determined based on the torque required for the torsion spring. That is, the spring drum 300 and the float 600 that satisfy the following equation may be selected and used.

F×r=k×θ [Equation 1]

Here, F may be the load acting on the wire, r may be the radius of the spring drum 300, k may be the stiffness of the torsion spring, and θ may be the allowable rotation angle of the torsion spring.

The weight of the float 600 may be selected differently according to the allowable rotation angle of the torsion spring, and the allowable rotation angle may be determined according to an expected groundwater depth. When the groundwater depth is expected to be deep, a torsion spring with a large allowable rotation angle should be used, and accordingly, a heavy float 600 should be used. On the other hand, when the groundwater depth is expected to be shallow, a torsion spring with a small allowable rotation angle may be used, and accordingly, a light float 600 may be used.

Accordingly, in the water level measurement system of the present disclosure, according to an expected or initially measured groundwater depth, one of different types of torsion springs and floats 600 may be selected and used.

According to one embodiment, the wire drum 100 may include an inner cylinder on which a wire is wound and an outer cylinder that prevents the wound wire from disengaging. A diameter of the outer cylinder may be proportional to the number of layers of the wound wire, and a length of the wire that may be wound per layer and the total number of layers of the wound wire may be calculated by the following equation:

n=w/d [Equation 2]

$$L = {\sum }_{i = 0}^{N - 1} ( 2 π ( {r}_{0} + i \cdot d ) \cdot n ) \qquad [ Equation 3 ]$$

$$L \approx 2 π n \cdot [ {r}_{0} N + \frac{dN ( N - 1 )}{2} ] .$$

Here, n may be the number of times at which the wire is wound per layer, w may be a width of the inner cylinder, and d may be a diameter of the wire. For example, when w is 200 mm and d is 4 mm, the wire may be wound 50 times per layer.

L may be a total length of the wire, r0 may be a diameter of the inner cylinder, and N may be the number of layers of the wire. After the total number N of layers of the wound wire is calculated using Equations 2 and 3, a diameter of the outer cylinder may be calculated using the following Equation 4:

Rⱼ=r₀+N·d. [Equation 4]

The wire drum 100 may rotate numerous times to wind the wire, and by calculating the diameters of the inner and outer cylinders in consideration of the total length of the wire, the wire may be stably wound without disengaging from the wire drum.

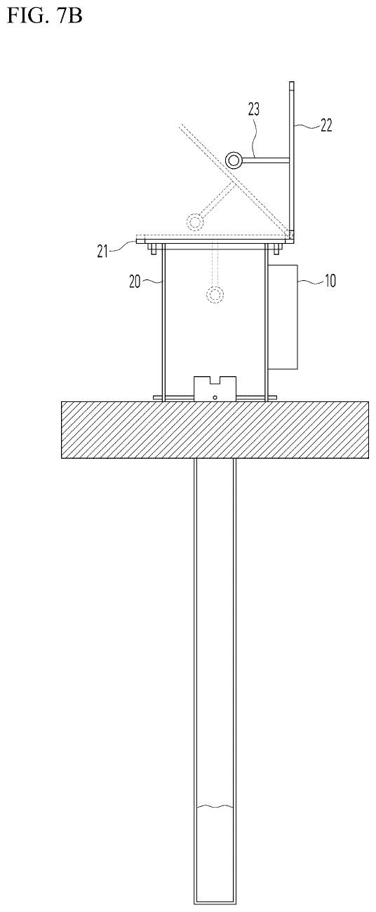

FIG. 7A is a view illustrating an embodiment in which a pulley 23 is installed perpendicular to a ground surface according to one embodiment.

According to the water level measurement system of the present disclosure, in the embodiment of FIGS. 1 to 6, a rotational surface of the pulley 23 installed on the cover 22 is disposed parallel to a ground surface. In this case, a wire passing through the pulley 23 may move only in a vertical direction, which makes it difficult to naturally draw the wire toward the ground surface.

On the other hand, in the embodiment of FIG. 7A, the pulley 23 may be disposed such that the rotational surface is perpendicular to the ground surface even when the cover 22 is closed. Accordingly, the wire moving through the pulley 23 may be drawn toward the ground surface, and a user may handle the wire more stably and conveniently. In particular, as compared to an existing structure in which the wire has been drawn only vertically, the wire may be drawn toward the ground surface, thereby reducing friction and bending of the wire and improving the reliability of long-term water level measurement work.

In addition, according to one embodiment of the present disclosure, when a groundwater level is measured for the first time, water level measurement may be performed directly without the wire being hung on the pulley 23. Initial water level measurement may be performed by directly connecting a wire between the float 600 and the wire drum 100 without passing through the pulley 23, thereby quickly and accurately obtaining an initial water level value.

After the initial water level value is measured, an installer may unwind the wire to hang the wire on the pulley 23. In such a process, a measurement stop instruction may be given to the water level measurement module 10 not to affect a water level measurement data while the wire is being unwound. The installer may operate a push button installed in the water level measurement module case to input a measurement stop instruction, and thereafter, after confirming that the wire is normally hung on the pulley 23, the installer may give a measurement resume instruction through the push button.

Such a control function can significantly contribute to preventing water level data errors caused by wire disengagement, a change in tension, or the like that may occur during an initial installation process, and improving the consistency and reliability of water level measurement. In addition, a manual instruction input method through the push button provides simplicity and intuitiveness to installers, thereby also improving the efficiency of installation work.

FIG. 7B is a view illustrating an embodiment in which a groundwater level is measured in a state in which the cover 22 of the groundwater protection work 20 is opened according to one embodiment.

Referring to FIG. 7B, in order to stably measure a groundwater level or lift the float 600 in a state in which the cover 22 of the groundwater protection work 20 is opened, a wire may be hung on the pulley 23 provided on the cover 22. For this purpose, the cover 22 of the groundwater protection work according to the present disclosure may rotate along an outer circumference of the flange 21. The cover 22 of the groundwater protection work 20 may be configured to support the stable movement of the wire even in an open state.

Specifically, the flange 21 is installed at an upper portion of the groundwater protection work 20, and the cover 22 is connected to the flange 21 through a hinge structure. The pulley 23 may be installed on the cover 22 so that the wire may be moved by being hung on the pulley 23. The pulley 23 serves to support and guide the wire to move along a predetermined path.

In particular, in the present disclosure, the cover 22 is designed to be rotatable along the outer circumference of the flange 21. A bearing may be installed between the cover 22 and the flange 21 so that a user may rotate the cover 22 to adjust a direction of the pulley 23. Thus, a drawing or winding direction of the wire may be optimized, and a movement path of the wire may be flexibly adjusted according to installation conditions of the groundwater protection work 20 or the user's convenience of work.

Since the cover 22 is rotatable, friction or bending of the wire may be minimized when the float 600 is lifted or a groundwater level is measured, thereby preventing damage to the wire or measurement errors. In addition, since a wire guidance function through the pulley 23 is maintained even in a state in which the cover 22 is opened, the stability of a system and convenience are significantly improved even when a worker inspects or replaces the float 600.

Therefore, the present disclosure provides a technical effect of simultaneously improving the efficiency and reliability of water level measurement and float lifting work in the groundwater protection work 20 through a combination of a rotation structure of the cover 22 and the pulley 23.

According to one embodiment, when a wire connected to the float 600 is guided through the pulley 23, a wire path is changed by the pulley 23, which may cause a difference between an actual movement distance of the wire and a vertical movement distance of the float 600. Accordingly, in order to accurately calculate a groundwater level, it is necessary to correct a water level in consideration of an increase in path length of the wire hung on the pulley 23.

Specifically, as the float 600 ascends or descends, the wire moves along the pulley 23, and a length of a wire section connecting the pulley 23 and the float 600 includes a path length from the pulley 23 to the float 600 in addition to a vertical distance. Thus, the total length of the wire wound on or unwound from the wire drum 100 is slightly greater than a vertical distance by which the float 600 actually moves.

In the present embodiment, an increase in length due to a change in wire path may be reflected in measurement to accurately calculate a groundwater level. That is, when a movement distance of the wire is calculated based on the number of rotations and a rotation direction of the wire drum 100 detected by the rotation measurement unit 400, a path length additionally generated due to the wire hung on the pulley 23 may be calculated and applied as a correction value for water level calculation.

For example, when a basic distance between the pulley 23 and the float 600 is fixed, such an additional length may be preset as a fixed value and added to the basic length and applied when a water level is calculated. On the other hand, when a path length between the pulley 23 and the float 600 changes according to a position of the float 600, a calculation logic that can dynamically reflect a change value may be included in the water level measurement module 10.

In this way, the present disclosure provides a method of reflecting a change in wire path length such that a groundwater level may be calculated with high accuracy even in a wire guide structure through a pulley 23.

In a water level measurement module according to exemplary embodiments of the present disclosure, even when a long wire needs to be used, the wire can be stably wound on or unwound from a wire drum, and a spring drum can continuously maintain wire tension, thereby enabling precise water level measurement without wire disengagement or loosening.

In addition, through a reduction structure using a gearbox, a rotation amount of a spring drum is minimized even when a long wire is wound or unwound, thereby significantly reducing a load applied to a spring. In particular, by implementing a reduction ratio of 768:1, a spring drum performs less than one rotation despite the movement of a long wire, thereby minimizing spring fatigue accumulation and improving the durability of a device.

In addition, the number of rotations of a wire drum is accurately measured with a wire encoder, thereby precisely calculating a groundwater level. Thus, it is possible to significantly improve the reliability of water level monitoring as compared to a related art.

In addition, through a combination of a structure of a spring drum and a gearbox, a long wire can be accommodated in a small drum, thereby reducing the size and weight of the entire device and improving the convenience of installation and maintenance.

In addition, in the present disclosure, stable water level monitoring is possible for a long period of time even in a low-power environment, which makes it effective for use in areas in which external power supply is difficult or in battery-powered operating conditions.

Effects that can be obtained from the exemplary embodiments of the present disclosure are not limited to the effects described above, and other effects that are not described can be clearly derived and understood by a person having ordinary skill in the art to which the exemplary embodiments of the present disclosure belong from the following description. That is, unintended effects resulting from the implementation of the exemplary embodiments of the present disclosure can also be derived from the exemplary embodiments of the present disclosure by a person having ordinary skill in the art.

Effects that can be obtained from the exemplary embodiments of the present disclosure are not limited to the effects described above, and other effects that are not described can be clearly derived and understood by a person having ordinary skill in the art to which the exemplary embodiments of the present disclosure belong from the following description. That is, unintended effects resulting from the implementation of the exemplary embodiments of the present disclosure can also be derived from the exemplary embodiments of the present disclosure by a person having ordinary skill in the art.

What is claimed is:

1. A groundwater protection work for measuring a groundwater level according to winding or unwinding a wire connected to a water level float, the groundwater protection work comprising:
a wire drum configured to wind the wire and store the wound wire;
a spring drum connected to at least one of a gearbox and the wire drum and configured to rotate in a forward or reverse direction according to tension of the wire to maintain the tension of the wire;
the gearbox disposed between the wire drum and the spring drum and configured to reduce rotation of the wire drum and transmit the reduced rotation to the spring drum; and
a rotation measurement unit configured to measure a rotation direction and the number of rotations by rotating together with the wire when the wire is wound on or unwound from the wire drum and measure the groundwater level based on the measured number of rotations.

2. The groundwater protection work of claim 1, wherein the spring drum includes a torsion spring having a rotation shaft aligned with that of at least one of the gearbox and the wire drum.

3. The groundwater protection work of claim 2, wherein required torque of the torsion spring is proportional to a load acting on the wire and a radius of the spring drum.

4. The groundwater protection work of claim 1, wherein the gearbox is connected to the spring drum while sharing a first rotation shaft and is connected to the wire drum while sharing a second rotation shaft different from the first rotation shaft, and
a rotation ratio of the second rotation shaft to the first rotation shaft is determined according to the number of gears included in the gearbox and a gear ratio of the gears.

5. The groundwater protection work of claim 1, wherein the gearbox has a reduction ratio of 768:1 by connecting five first gears having a gear ratio of 1:4 to one second gear having a gear ratio of 1:3.

6. The groundwater protection work of claim 5, wherein, when the wire drum rotates 768 times, the spring drum rotates at an angle of 270 degrees or less.

7. The groundwater protection work of claim 1, wherein the spring drum rotates less than one revolution while the wire drum winds a wire with a length of 200 m or more.
